(19) United States
(12) Patent Application Publication
(10) Pub. No.: US 2013/0033781 A1
(43) Pub. Date: Feb. 7, 2013

(54) BASE FOR MOTOR AND HARD DISK DRIVE INCLUDING THE SAME

(71) Applicants: Hyun Chul LEE, Seoul (KR); Tae Young Choi, Yongin (KR)

(72) Inventors: Hyun Chul LEE, Seoul (KR); Tae Young Choi, Yongin (KR)

(73) Assignee: Samsung Electro-Mechanics Co., Ltd., Suwon (KR)

(21) Appl. No.: 13/347,148

(22) Filed: Jan. 10, 2012

(30) Foreign Application Priority Data
Aug. 5, 2011 (KR) 10-2011-0078211

(51) Int. Cl. G11B 21/02; B32B 3/02; G11B 15/18

(52) U.S. Cl. 360/75; 428/192; G9B/21.003; G9B/15.021

(57) ABSTRACT

There is provided a base for a motor, the base including: a base body having a disk disposed thereon; an outer wall part formed on the base body to thereby define an outer edge of the base body; and a fixing part formed in at least one of the base body and the outer wall part in order to fix the base body and a substrate, to which power is applied, to each other, thereby supporting upper and lower surfaces of the substrate.

### CROSS-REFERENCE TO RELATED APPLICATIONS

This application claims the priority of Korean Patent Application No. 10-2011-0078211 filed on Aug. 5, 2011, in the

Korean Intellectual Property Office, the disclosure of which is incorporated herein by reference.

### BACKGROUND OF THE INVENTION

1. Field of the Invention

The present invention relates to a base for a motor and a hard disk drive including the same, and more particularly, to a base for a motor having an improved coupling structure between the base and a substrate, and a hard disk drive including the same.

2. Description of the Related Art

A hard disk drive (HDD), an information storage device for a computer, reads data stored on a disk or writes data to the disk using a magnetic head.

In a hard disk drive, a base is installed with a head driver, that is, a head stack assembly (HSA), capable of altering a position of the magnetic head relative to the disk. The magnetic head performs its function while moving to a desired position in a state in which it is suspended above a writing surface of the disk at a predetermined height by the head driver.

According to the related art, in manufacturing a base provided in the hard disk drive, a post-processing scheme of die-casting aluminum (Al) and then removing therefrom burrs, or the like, generated due to the die-casting, has been used.

However, in the die-casting scheme according to the related art, since a process of injecting molten aluminum (Al) for the casting thereof to form a base is performed, high temperature and pressure are required, such that large amounts of energy are required in the process and a process time is increased.

Further, even in terms of a lifespan of a die-casting mold, there is a limitation in manufacturing a large number of bases using a single mold, and a base manufactured by the die-casting process may have poor dimensional precision.

Therefore, in order to solve defects occurring due to the die-casting process, the base has been manufactured using a pressing or forging method. However, in the case of the pressing or forging method, there is a limitation that the base can only have a uniform thickness, due to a process of bending and cutting a plate.

Therefore, in the case in which the base is manufactured by the pressing or forging method, it is difficult to manufacture a coupling part required for fixing a substrate.

Therefore, research into an improved structure, even in the case that a base is manufactured through a pressing or forging method, by overcoming a limitation that a base can only have a uniform thickness has been urgently required.

### SUMMARY OF THE INVENTION

An aspect of the present invention provides a base for a motor capable of improving productivity and significantly reducing manufacturing costs through having a simplified coupling structure between the base and a substrate, even in the case of using a pressing or forging method, and a hard disk drive including the same.

According to an aspect of the present invention, there is provided a base for a motor, the base including: a base body having a disk disposed thereon; an outer wall part formed on the base body to thereby define an outer edge of the base body; and a fixing part formed in at least one of the base body and the outer wall part in order to fix the base body and a substrate, to which power is applied, to each other, thereby supporting upper and lower surfaces of the substrate.

The fixing part may include a protrusion part protruded from at least one of the base body and the outer wall part, and upper and lower surface supporting parts protruded from the protrusion part to thereby support the upper and lower surfaces of the substrate, respectively.

The lower surface supporting part may be formed by bending an end portion of the protrusion part.

At least one of the upper and lower surface supporting parts maybe formed by depressing one surface of a predetermined region of the protrusion part to protrude the other surface thereof.

The upper surface supporting part may be formed by cutting and bending a predetermined region of the protrusion part.

The upper surface supporting part may be protruded by performing a burring process on a predetermined region of the protrusion part.

The base body and the outer wall part may be formed by a pressing process.

According to another aspect of the present invention, there is provided a hard disk drive including: the base for a motor as described above; a spindle motor coupled to the base and rotating the disk by the power applied through the substrate; a magnetic head writing data to the disk and reproducing the data stored on the disk; and a head driver moving the magnetic head to a predetermined position with regard to the disk.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view showing a hard disk drive including a base for a motor according to an embodiment of the present invention;

FIG. 2 is an exploded perspective view showing a disposition relationship between a base for a motor and a substrate according to an embodiment of the present invention;

FIG. 3 is an exploded perspective view showing a coupling relationship between a base for a motor and a substrate according to an embodiment of the present invention;

FIG. 4 is a schematic cross-sectional view taken along line A-A of FIG. 3;

FIGS. 5A and 5B are schematic cross-sectional views showing a method of manufacturing part B of FIG. 3 and a state thereof after being manufactured;

FIGS. 6A and 6B are schematic cross-sectional views showing a method of manufacturing part B of FIG. 3 according to another embodiment of the present invention and a state thereof after being manufactured;

FIGS. 7A and 7B are schematic cross-sectional views showing a method of manufacturing part B of FIG. 3 according to another embodiment of the present invention and a state thereof after being manufactured;

FIGS. 8A and 8B are schematic cross-sectional views showing a method of manufacturing part B of FIG. 3 according to another embodiment of the present invention and a state thereof after being manufactured; and

FIGS. 9A and 9B are schematic cross-sectional views showing a method of manufacturing part B of FIG. 3 according to another embodiment of the present invention and a state thereof after being manufactured.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

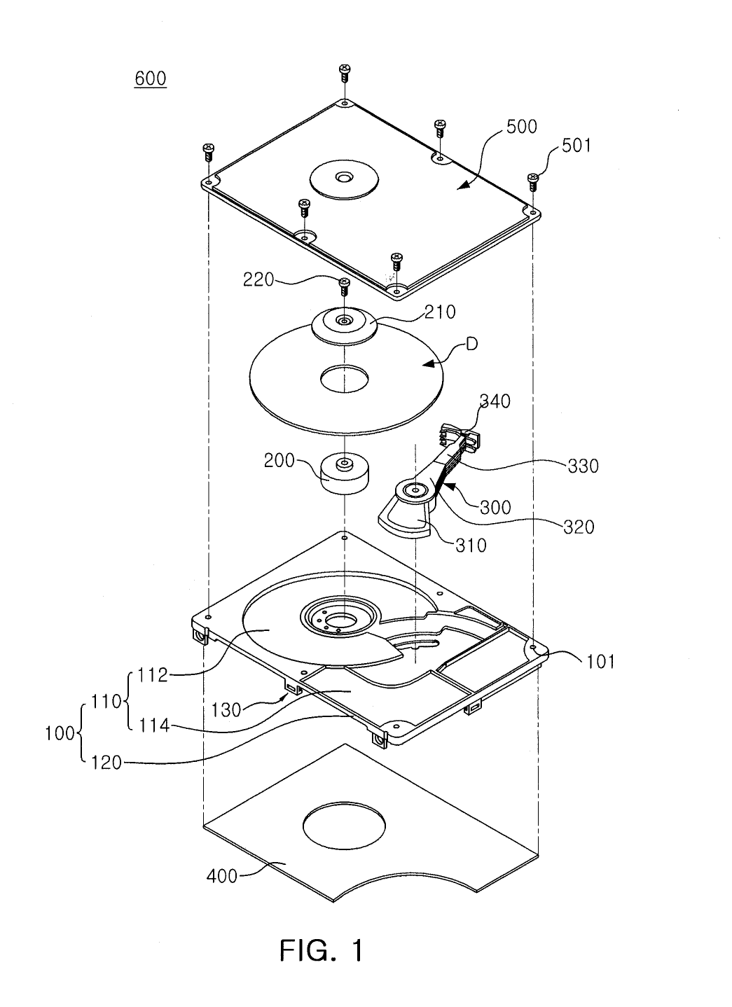

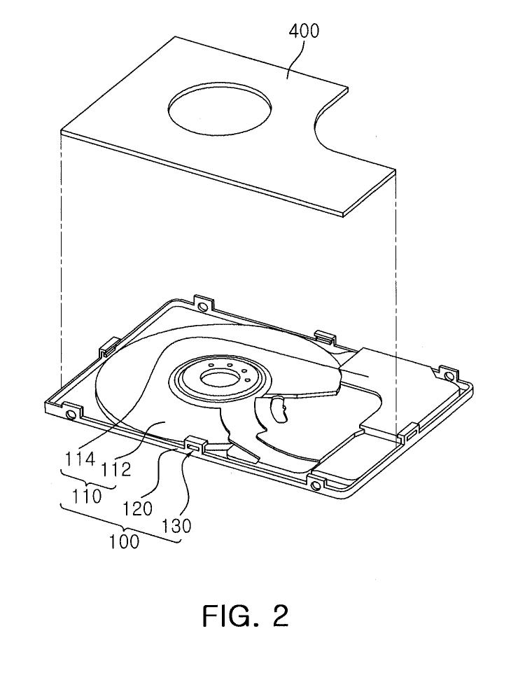

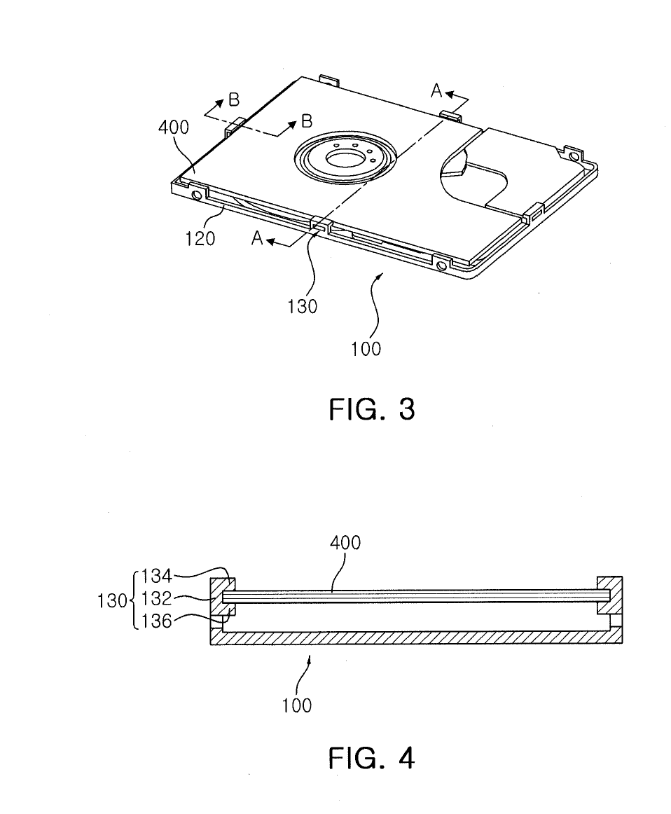

FIG. 1 is an exploded perspective view showing a hard disk drive including a base for a motor according to an embodiment of the present invention; FIG. 2 is an exploded perspective view showing a disposition relationship between a base for a motor and a substrate according to an embodiment of the present invention; FIG. 3 is an exploded perspective view showing a coupling relationship between a base for a motor and a substrate according to an embodiment of the present invention; and FIG. 4 is a schematic cross-sectional view taken along line A-A of FIG. 3 (In FIG. 4, main components of the base for a motor are omitted).

Referring to FIGS. 1 through 4, a hard disk drive 600 including a base 100 for a motor according to an embodiment of the present invention may include the base 100 for a motor, a spindle motor 200, and a head driver 300 for moving a magnetic head.

Terms with respect to directions will be first defined. An upward or downward axial direction refers to a direction from an upper surface of the base 100 toward a cover 500 or a direction opposite thereto, and an outer or inner radial direction refers to a direction from an outer wall part 120 of the base 100 toward the center of a disk D or a direction opposite thereto.

The base 100 may be a housing forming an exterior appearance together with the cover 500 in the hard disk drive 600 according to the embodiment of the present invention, and include a base body 110, the outer wall part 120, and a fixing part 130.

Here, the base 100 and the cover 500 may be coupled to each other by coupling a plurality of screws 501 to holes 101 formed in the base 100.

The base body 110 may have a disk D disposed thereon and the head driver 300 coupled thereto, and the disk D is coupled to the spindle motor 200 to be described below.

More specifically, the base body 110 may be partially protruded in the downward axial direction, wherein the partially protruded regions may be a disk receiving part 112 and a head seating part 114.

The disk receiving part 112 may generally have a circular shape so as to correspond to a shape of the disk, and the head seating part 114 is formed at the periphery of the disk receiving part 112 and is coupled to the head driving part 300 capable of reproducing data stored on the disk D.

The outer wall part 120 may be formed at outer edges of the base body 110 to thereby define the outer surfaces of the base body 110 and be formed by bending edge portions of the base body 110.

Here, the base body 110 and the outer wall part 120 may be formed by a forging or pressing process and be manufactured by disposing a plate-shaped steel sheet, that is, a cold rolled steel sheet (SPCC, SPCE, or the like), a hot rolled steel sheet, a lightweight alloy steel sheet formed of a material such as stainless steel, boron or magnesium alloy, or the like, in a press mold and pressing the plate shaped steel at a predetermined pressure.

In other words, the shape of an internal space formed by a combination of upper and lower molds for pressing or forging corresponds to the shapes of the outer wall part 120 and the base body 110, such that the base 100 according to the embodiment of the present invention may be manufactured by a single process.

However, a basic shape of the base may be formed by a single pressing process, and then a final shape of the base 100 maybe the formed by a bending process and an additional pressing process.

In this case, the outer wall part 120 may be formed by being bent at the outer edge portions of the base body 110 in the downward axial direction, or being bent therefrom in the upward axial direction and then bent in the downward axial direction.

The outer wall part 120 may be formed by the above-mentioned process, and the fixing part 130 for fixing a substrate 400 to which power is applied may be formed by performing an additional process.

Here, the fixing part 130, capable of simultaneously supporting upper and lower surfaces of the substrate 400 to thereby couple the substrate 400 to the base 100 without a separate coupling member, may include a protrusion part 132, a lower surface supporting part 134, and an upper surface supporting part 136.

The protrusion part 132 maybe protruded from the edge portion of the outer wall part 120, and the upper surface supporting part 136 and the lower surface supporting part 134 may be protruded from the protrusion part 132 in the inner radial direction.

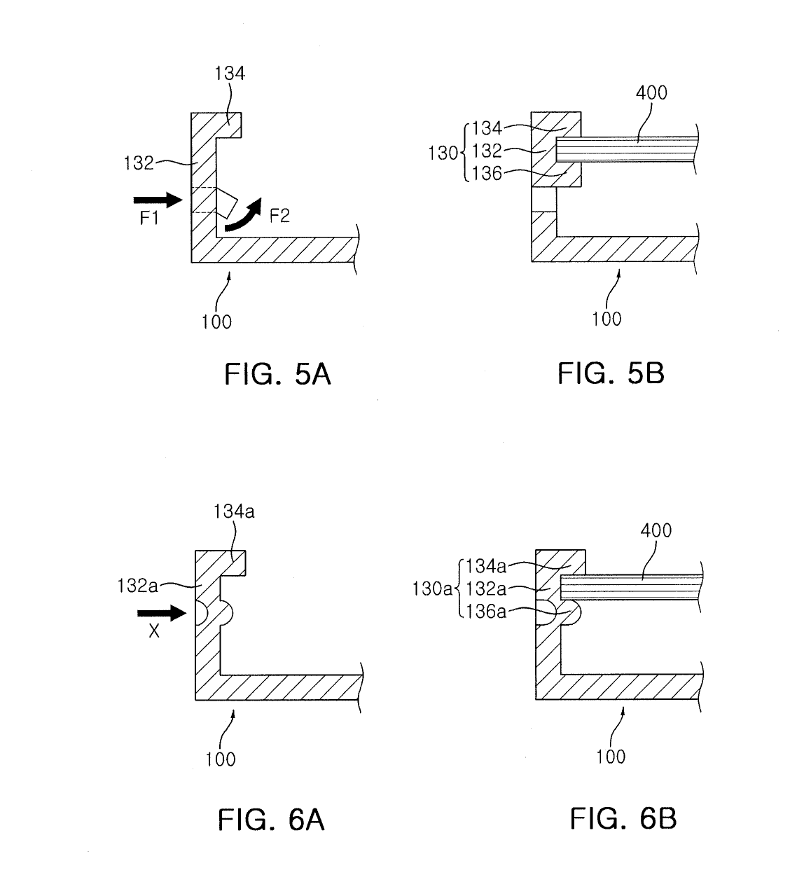

A detailed manufacturing method thereof will be described below with reference to FIGS. 5 through 8.

At least one protrusion part 132 may be formed using a portion of a region of the outer wall part 120, and the lower surface supporting part 134 may be formed by bending an end portion of the protrusion part 132 in the inner radial direction.

Therefore, in coupling the substrate 400 to the base 100, a structure for supporting the lower surface of the substrate 400 may be obtained. In addition, the upper surface supporting part 136 supporting the upper surface of the substrate 400 may be formed by cutting a predetermined region of the protrusion part 132 and then bending the cut region in the inner radial direction.

Therefore, since the substrate 400 may be fixed to the base 100 by the upper surface supporting part 136 and the lower surface supporting part 134, a separate coupling member such as a nut, or the like is not required, such that an increase in costs due to an increase in the number of processes and components may be prevented.

In addition, since the fixing part 130 including the protrusion part 132, the upper surface supporting part 136, and the lower surface supporting part 134 may be formed by bending the plate-shaped steel sheet, which is the base material of the base 100, the fixing part 130 may be formed at the same time of producing the base 100.

However, the substrate 400 may also be coupled to the base 100 using a separate coupling member such as a nut, or the like, together with the fixing part 130 including the protrusion part 132, the upper surface supporting part 136, and the lower surface supporting part 134.

Additionally, the protrusion part 132 positioned between the upper surface supporting part 136 and the lower surface supporting part 134 may support a side of the substrate 400.

Although FIGS. 1 through 4 show that the fixing part 130 is formed in the outer wall part 120, the present invention is not limited thereto. That is, the fixing part 130 may also be formed at a predetermined region of the base body 110.

However, in this case, the substrate 400 may have a hole formed at a predetermined region thereof and be fixed to the fixing part 130 of the base body 110 by inserting the fixing part 130 into the hole.

The spindle motor 200, which is to rotate the disk D, is fixedly mounted to a central portion of the disk receiving part 112. The disk D may be coupled to the spindle motor 200 to thereby be rotated together with the spindle motor 200, and may have a writing surface to which data is written.

Here, a clamp 210 may be coupled to an upper end portion of the spindle motor 200 using a screw 220 in order to firmly fix the disk D to the spindle motor 200.

In addition, although FIG. 1 shows a configuration in which a single disk D is mounted on the spindle motor 200, this configuration is only an example. That is, one or more disks D may be mounted on the spindle motor 200. In the case in which a plurality of disks D are mounted as described above, a ring-shaped spacer for maintaining an interval between the disks D may be disposed therebetween.

The head driver 300 is known as a head stack assembly (HAS) and may be a component having a magnetic head (not shown) mounted thereon and moving the magnetic head to a predetermined position to thereby write data to the disk D or read the data from the disk D.

The head driver 300 may include a voice coil motor (VCM) 310, a swing arm 320, and a suspension 330. The suspension 330 may be fixedly coupled to a front end portion of the swing arm 320.

In addition, the head driver 300 maybe coupled to the base 100 so as to be rotatable around a pivot of the base 100. When the disk D rotates on the disk receiving part 112 of the base body 110 at a high speed, the magnetic head (not shown) serves to reproduce the data written on the writing surface of the disk D or write data to the writing surface of the disk D.

Here, the VCM 310, providing rotational driving force to the head driver 300, may include magnets disposed on upper and lower portions of a VCM coil of the head driver 300.

The VCM 310 maybe controlled by a servo control system and rotate the head driver 300 around the pivot in a direction according to Fleming's left hand rule by an interaction between current input to the VCM coil and a magnetic field formed by the magnet.

Here, when an operation start command is input to the hard disk drive 600 according to the embodiment of the present invention, the disk D starts to rotate, and the VCM 310 rotates the swing arm 320 in a counterclockwise direction to thereby move the magnetic head (not shown) onto the writing surface of the disk D.

On the other hand, when an operation stop command is input to the hard disk drive 600 according to the embodiment of the present invention, the VCM 310 rotates the swing arm 320 in a clockwise direction to thereby allow the magnetic head (not shown) to move away from the disk D.

The magnetic head (not shown) deviating from the writing surface of the disk D is parked in a ramp 340 provided outside the disk D.

FIG. 5 is a schematic cross-sectional view showing a method of manufacturing part B of FIG. 3 and a state thereof after being manufactured.

Referring to FIG. 5, after the base body 110 and the outer wall part 120 are formed by the pressing or forging process and the additional bending or pressing process, the protrusion part 132 configuring the fixing part 130 is formed by being extended from the end portion of the outer wall part 120 in the downward axial direction.

Thereafter, the lower surface supporting part 134 may be formed by bending the end portion of the protrusion part 132 in the inner radial direction.

In addition, the upper surface supporting part 136 may be formed by cutting a predetermined region of the protrusion part 132 by punching (F1), or the like, and then bending (F2) the cut region in the inner radial direction.

Here, the region cut in order to implement a shape of the upper surface supporting part 136 may be sealed by a separate sealing member.

In addition, an interval between the lower surface supporting part 134 and the upper surface supporting part 136 may correspond to a thickness of the substrate 400, but may also have a slight margin of error, as long as the substrate 400 may be fixed to the base 100.

Additionally, the fixing part 130 including the protrusion part 132, the lower surface supporting part 134, and the upper surface supporting part 136 may be formed in a predetermined region of the base body 110 as well as the outer wall part 120.

FIG. 6 is a schematic cross-sectional view showing a method of manufacturing part B of FIG. 3 according to another embodiment of the present invention and a state thereof after being manufactured.

Referring to FIG. 6, a protrusion part 132a of a fixing part 130a may be formed by being extended from the end portion of the outer wall part 120 in the downward axial direction, and a lower surface supporting part 134a thereof may be formed by bending an end portion of the protrusion part 132a in the inner radial direction.

Here, an upper surface supporting part 136a supporting the upper surface of the substrate 400 may be formed by performing an embossing process on a predetermined region of the protrusion part 132a.

That is, the upper surface supporting part 136a may be formed to be protruded in the inner radial direction by pressing (X) a predetermined region of the protrusion part 132, in consideration of a thickness of the substrate 400 or allowing for a slight margin of error, in the inner radial direction.

In other words, the upper surface supporting part 136a may be formed by depressing one surface of the predetermined region of the protrusion part 132a such that the other surface thereof corresponding thereto may be protruded.

However, the upper surface supporting part 136a protruded in the inner radial direction may have a cross-sectional shape close to a circular shape as shown in FIG. 6, but it is not limited thereto. That is, the upper surface supporting part 136a may have any structure capable of supporting the upper surface of the substrate 400.

Additionally, the fixing part 130a including the protrusion part 132a, the lower surface supporting part 134a, and the upper surface supporting part 136a may be formed in a predetermined region of the base body 110 as well as the outer wall part 120.

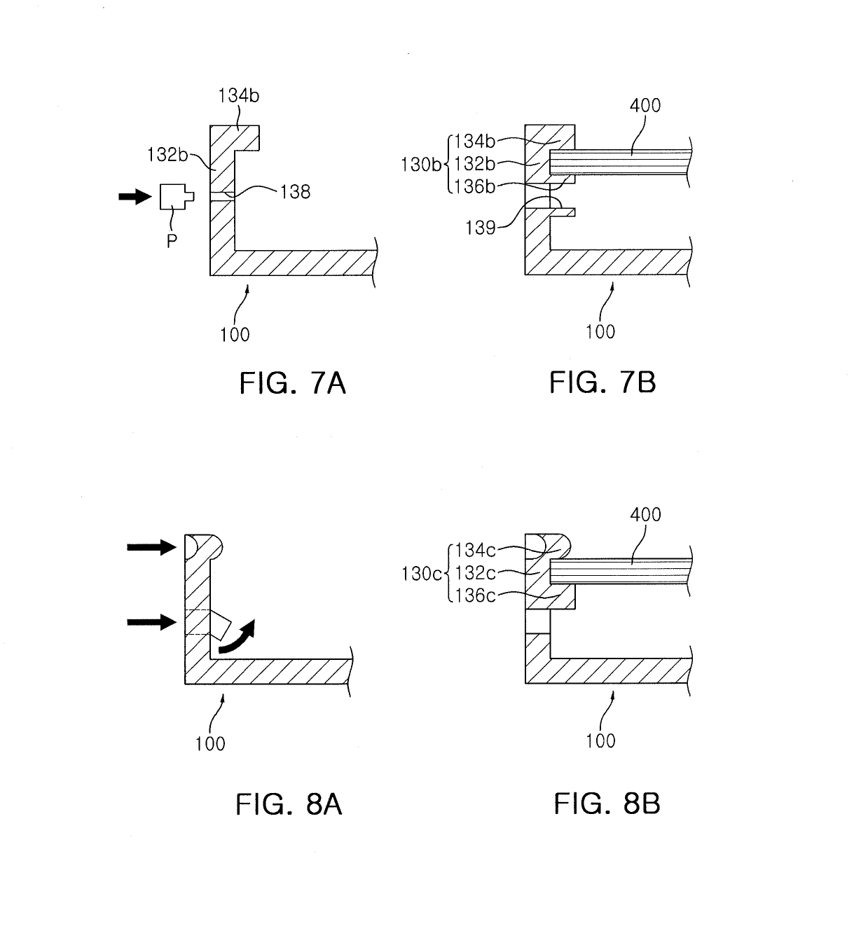

FIG. 7 is a schematic cross-sectional view showing a method of manufacturing part B of FIG. 3 according to another embodiment of the present invention and a state thereof after being manufactured.

Referring to FIG. 7, a protrusion part 132b of a fixing part 130b may be formed by being extended from the end portion of the outer wall part 120 in the downward axial direction, and a lower surface supporting part 134b thereof may be formed by bending an end portion of the protrusion part 132b in the inner radial direction.

Here, an upper surface supporting part 136b supporting the upper surface of the substrate 400 may be protruded by performing a burring process on a predetermined region of the protrusion part 132b.

That is, the upper surface supporting part 136b may be protruded in the inner radial direction by punching a predetermined region of the protrusion part 132b to form a hole 138 and then pressing a punch P having a diameter slightly larger than that of the hole 138 toward the hole 138 in the inner radial direction.

The upper surface supporting part 136b formed by the burring process as described above may include a hole 139 having a predetermined diameter and stably support the upper surface of the substrate 400.

Additionally, the fixing part 130b including the protrusion part 132b, the lower surface supporting part 134b, and the upper surface supporting part 136b may be formed in a predetermined region of the base body 110 as well as the outer wall part 120.

FIG. 8 is a schematic cross-sectional view showing a method of manufacturing part B of FIG. 3 according to another embodiment of the present invention and a state thereof after being manufactured.

Referring to FIG. 8, a protrusion part 132c of a fixing part 130c maybe formed by being extended from the end portion of the outer wall part 120 in the downward axial direction, a lower surface supporting part 134c thereof may be formed by an embossing process, and an upper surface supporting part 136c thereof may be formed by cutting a predetermined region of the protrusion part 132c.

That is, the lower surface supporting part 134c may be the same as the upper surface supporting part 136a depicted in FIG. 6, and the upper surface supporting part 136c may be the same as the upper surface supporting part 136 depicted in FIG. 5.

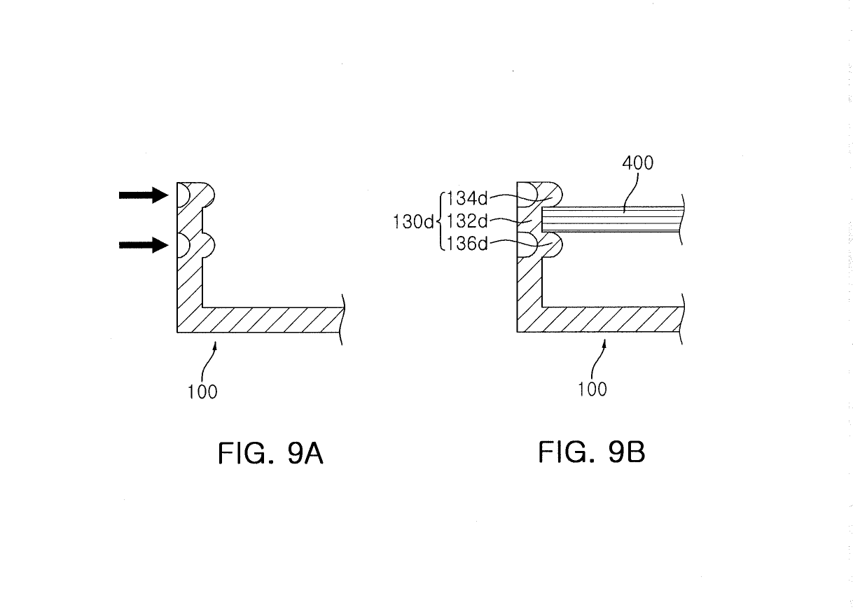

FIG. 9 is a schematic cross-sectional view showing a method of manufacturing part B of FIG. 3 according to another embodiment of the present invention and a state thereof after being manufactured.

Referring to FIG. 9, a protrusion part 132d of a fixing part 130d may be formed by being extended from the end portion of the outer wall part 120 in the downward axial direction.

In addition, both an upper surface supporting part 136d and a lower surface supporting part 134d, respectively supporting the upper and lower surfaces of the substrate 400, may be formed by an embossing process and be the same as the upper surface supporting part 136a depicted in FIG. 6 and the lower surface supporting part 134c depicted in FIG. 8, respectively.

According to the above-mentioned embodiments, a separate coupling member for coupling the base manufactured by the pressing or forging process and the substrate, to which power is applied, to each other is not required, whereby productivity may be improved and production costs may be significantly reduced.

In addition, since the fixing part 130, 130a, 130b, 130c, or 130d including the protrusion part 132, 132a, 132b, 132c, or 132d, the upper surface supporting part 136, 136a, 136b, 136c, or 136d, and the lower surface supporting part 134, 134a, 134b, 134c, or 134d may be formed by bending or embossing the plate-shaped steel sheet, which is the base material of the base 100, the fixing part 130, 130a, 130b, 130c, or 130d may be formed during the producing of the base 100.

As set forth above, in a base for a motor and a hard disk drive including the same according to embodiments of the present invention, a coupling structure between the base and a substrate may be simplified even in the case of using a pressing or forging process.

In addition, the base for a motor is manufactured by the forging or pressing process to significantly reduce processing time and energy consumption, whereby the productivity may be improved.

While the present invention has been shown and described in connection with the embodiments, it will be apparent to those skilled in the art that modifications and variations can be made without departing from the spirit and scope of the invention as defined by the appended claims.

1. A base for a motor, formed of a steel sheet, the base comprising:
a base body having a disk disposed thereon;
an outer wall part formed on the base body to thereby define an outer edge of the base body; and
a fixing part formed in at least one of the base body and the outer wall part in order to fix the base body and a substrate, to which power is applied, to each other, thereby supporting upper and lower surfaces of the substrate,
the fixing part including a protrusion part protruded from at least one of the base body and the outer wall part, and upper and lower surface supporting parts protruded from the protrusion part to thereby support the upper and lower surfaces of the substrate, respectively.

2. (canceled)

3. The base of claim 1, wherein the lower surface supporting part is formed by bending an end portion of the protrusion part.

4. The base of claim 1, wherein at least one of the upper and lower surface supporting parts is formed by depressing one surface of a predetermined region of the protrusion part to protrude the other surface thereof.

5. The base of claim 1, wherein the upper surface supporting part is formed by cutting and bending a predetermined region of the protrusion part.

6. The base of claim 1, wherein the upper surface supporting part is protruded by performing a burring process on a predetermined region of the protrusion part.

7. The base of claim 1, wherein the base body and the outer wall part are formed by a deformation of a steel sheet.

8. A hard disk drive comprising:
the base for a motor of claim 1;
a spindle motor coupled to the base and rotating the disk by the power applied through the substrate;
a magnetic head writing data to the disk and reproducing the data stored on the disk; and
a head driver moving the magnetic head to a predetermined position with regard to the disk.
